(19) United States
(12) Patent Application Publication
(10) Pub. No.: US 2012/0130770 A1
(43) Pub. Date: May 24, 2012

(54) METHOD AND APPARATUS TO MONITOR HUMAN ACTIVITIES IN STUDENTS' HOUSING

(76) Inventors: James W. Heffernan, Brookfield, WI (US); James D. Letchinger, Chicago, IL (US)

(21) Appl. No.: 12/950,781

(22) Filed: Nov. 19, 2010

(51) Int. Cl. G06Q 10/00; G06Q 30/00

(52) U.S. Cl. 705/7.32; 705/14.11; 705/7.29

(57) ABSTRACT

A method and apparatus for collection of ethnographic data from a building housing a population, which includes modern surveillance equipment, marketing and other testing materials, and may comprise an agreement between the dormitory and a dormitory sponsor to collect ethnographic data and provide test products and other materials in a dormitory equipped as a real-world social laboratory. This synergy between dormitory sponsorship, dormitory management, and students allows for easy, organized and cost effective experimentation and data mining of the valuable student demographic with incentive to the parties involved.

### BACKGROUND OF THE INVENTION

1. Field of the Invention

The present invention relates in general to the field of human subject monitoring for ethnographic research. More particularly, the present invention relates to identifying and adapting environs that are optimal for collecting ethnographic data. Such environs include those dwellings which have relatively constant turnover and demographic makeup, such as college dormitories and apartment buildings. The housing is adapted and utilized as a real-world social laboratory to collect ethnographic data from subjects while they go about their daily lives. In a preferred embodiment, such facilities include integrated monitoring and marketing facilities as well as data-mining and analysis methods that gather, store, and provide the information collected from these facilities.

2. Background and Summary of the Invention

Behavioral research with human subjects is typically done in a laboratory setting. This type of research is costly due to the expense of hosting the subjects while gathering the data. In addition, it is difficult to obtain subjects who are willing to devote lengthy times to onsite experimentation.

Other methods of studying human subjects involve ethnographic research, wherein data is collected in the real-world. Field research in the outside world is also costly because it involves methods of gathering data from the subjects such as lengthy observations, recording, surveys, interviews, and panel discussions in focus groups. Typically, ethnographic research involves the researcher (ethnographer) living among the subjects and recording their activities in notebooks and audio recordings. As well, certain subjects (informants) may be interviewed at length to gather data that cannot be directly observed in real time by the ethnographer. Interviewing techniques, including surveys, may also be less accurate because the subjects are not observed, but are asked to answer questions and may have faulty recall or otherwise provide incorrect responses. The activities of the human subjects can also be affected by having the ethnographer in the midst of the subjects, leading to inaccurate observations. In addition, ethnographic research may also be lengthy requiring a space of time to introduce the testing materials and to gather data on the reactions of the subjects.

Thus, ethnographers skilled in the art have found that factors, such as time, cost, and accuracy, are obstacles to providing useful, accurate, and inexpensive ethnographic data. Achieving improvements in ethnographic data collection, therefore, can serve to reduce cost, provide more accurate data, and save researchers' time.

Furthermore, it would be especially beneficial and valuable if improvements in ethnographic data collection could be achieved by leveraging certain common characteristics of a sought after demographic group. For instance, marketing firms, product manufacturers, and retail establishments have a keen interest in collection of ethnographic data from a key market demographic: students. In general, students are early adopters of new technology, styles, and ideas. As such, they are early indicators of changes in market tastes, as well as providing a large and relatively active market for various products. Because of their unique characteristics and buying power ethnographic data about students is a valued commodity. What the inventors have identified is that students also share a common characteristic that if leveraged properly can be utilize to achieve improvements in the collection of ethnographic data. Namely, students are often housed together in controlled environments, such as dormitories and housing projects. By applying technological advances in the collection of ethnographic data to a population that is both ethnographically desirable and ideally situated for ethnographic collection, a new apparatus for and method of gathering ethnographic data is provided.

In one embodiment a method of collecting ethnographic data from a population in a building is provided. An identification attribute for at least one member of the population is identified. At least one area is provided within or proximate to the building, with a member detection device. The member detection device is utilized to identify the member when the member is within the area. Member activity information is compiled when the member is located within the area.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views. Preferred exemplary embodiments of the invention are illustrated in the accompanying drawings in which like reference numerals represent like parts throughout, and in which:

FIG. 1 is a perspective view of a lobby with a coffee shop in a first embodiment of a dormitory for gathering ethnographic data of the present invention;

FIG. 2 is a perspective view of a video viewing area of the present invention;

FIG. 3 is a perspective view of a lobby with a front desk and a dormitory sponsor's product;

FIG. 4 is a perspective view of a students' apartment of the present invention;

FIG. 5 is a perspective view of an exercise room of the present invention;

FIG. 6 is a flow chart of a method of the present invention;

FIG. 7 is a block diagram of the dormitory ethnographic data collection apparatus of the present invention;

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

Specific embodiments of the present invention will now be further described by the following, non-limiting examples which will serve to illustrate various features of significance.

The following embodiments are intended merely to facilitate an understanding of ways in which the present invention may be practiced and to further enable those of skill in the art to practice the present invention. Accordingly, the examples should not be construed as limiting the scope of the present invention. The present invention and the various features and advantageous details thereof are explained more fully with reference to the non-limiting embodiments described in detail in the following description.

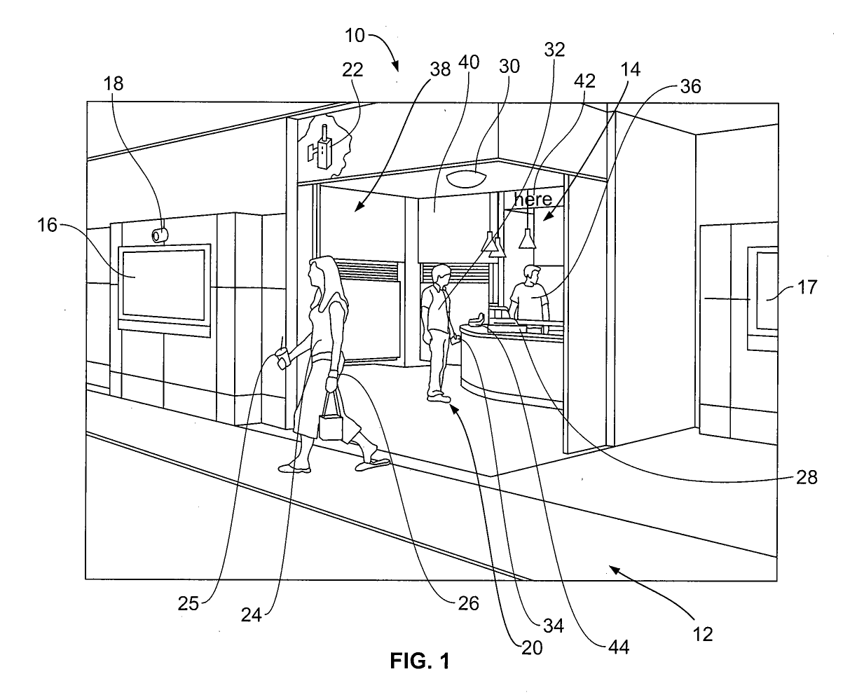

Referring now to FIG. 1, in the preferred embodiment 10 a portion of a lobby 12 and a coffee shop 14 within a student housing complex, such as a dormitory, is shown. The lobby has a video viewing device such as televisions 16, 17 along with a device for recording video and audio in the form of a video surveillance camera 18 proximate to the television 16 such that the viewing audience of television 16 (not shown) can be monitored for gathering ethnographic data. The coffee shop 14 has an entryway 20 having an identifier detection device 22 that detects the student 24 having student identifier. In one example, the identifier detection device 22 utilizes a wireless technology, such as Wi-Fi or RFID to determine that the student is located in a particular area. For instance, a student could wear an identifier, such as a bracelet 26 having an RFID tag that would communicate with an identifier detection device 22, such as an RFID tag reader, while student 24 is in a particular location. In another example, the wireless detection device 22 could be a Wi-Fi transceiver with functionality that would identify when a user connected to a Wi-Fi network. In another example, the identifier could be an application that interacts with a GPS chip or functional block on a portable electronic device. Such application could notify a server (acting alone or in combination with the application or GPS functionality as identifier detection device 22) that student 24 is present in a location. In a further example, student 24 could manually inform identifier detection device 22 of their location by means, such as swiping a key fob or identification card, entering a user name and password into a terminal, or identifying their presence or entering their location into an application on a mobile phone or portable device.

Continuing to refer to FIG. 1, in one example, the student 24 is detected when she is in a particular vicinity of detection device 22 such as when she leaves the coffee shop (as shown) or upon entry. The information detected comprises a unique identifier that is read from the student identifier 26, which can be associated with additional information such as a time and date stamp and a location. In addition, a purchased product 25 can have an identifier and can also be detected by identifier detection device 22.

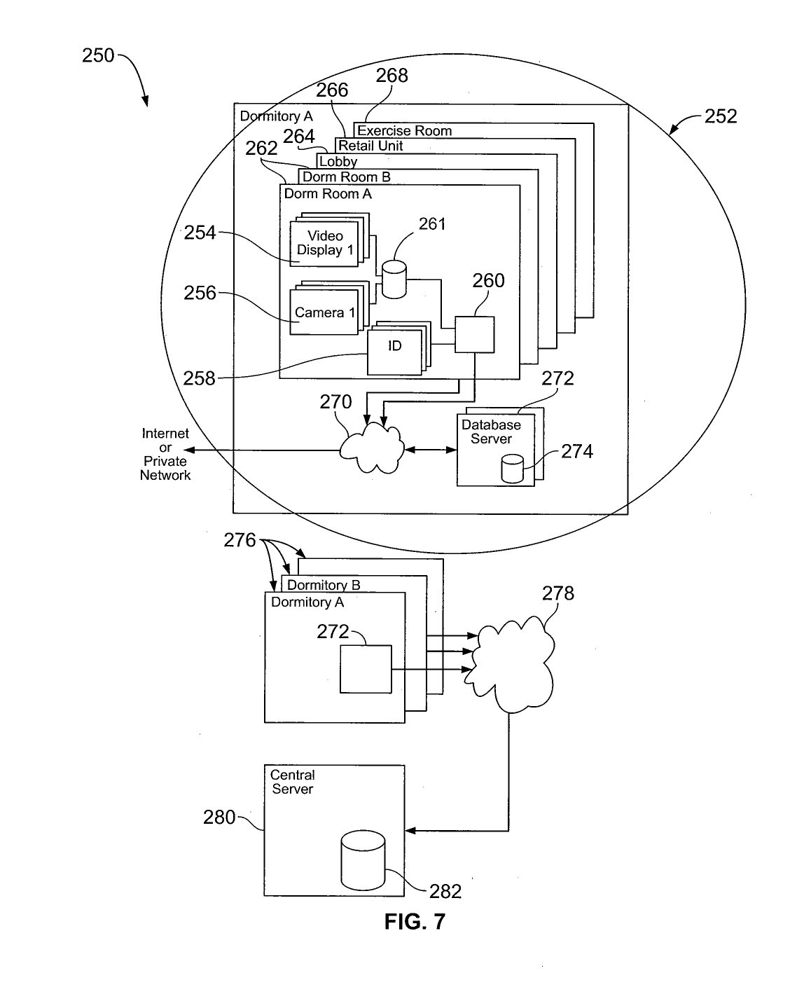

The retail unit coffee shop 14 in one example 10 comprises a sales terminal such as cash register 28 and an identifier detection device 22, such as card reader 44. In an exemplary retail transaction the student 32 purchases an item (not shown) using student identifier 34. The student identifier 34, a dormitory or campus-based debit or credit card which identifies the student, is swiped in card reader 44 and captures the student's identity, cost of the transaction, and the item(s) purchased. This information can be associated with additional information such as a time and date stamp and the coffee shop 14 location. The video surveillance system 30 may also capture more associated information such as the content of the conversation between student 32 and cashier 36. Images and audio from the video camera 30 may also be used to identify the students based upon facial recognition and voice recognition. In addition, the coffee shop 14 contains point-of-sales media such as the coffee advertisements 38, 40 which may be displayed as still media or video playback under the control of a media server (or other server, neither is shown). Finally, the coffee shop may contain point-of-sales branding 42, which is a mark—either a third party mark such as a dormitory sponsor or a mark from the property owner or management. All of the above information, including the video, audio, transaction details, entry/exit from coffee shop, and the point-of-sales media and branding displayed, can be added to the database and associated with the unique student or students to form a portion of the ethnographic data that is gathered in the preferred embodiment 10. The information is transmitted to the database server by video surveillance devices 18, 30 and detection device 22, which are connected via a hard wired cable or wirelessly to a computer network having access to the database server (not shown). The structure of the computer networks and various clients and servers therein will be detailed in FIG. 7 below.

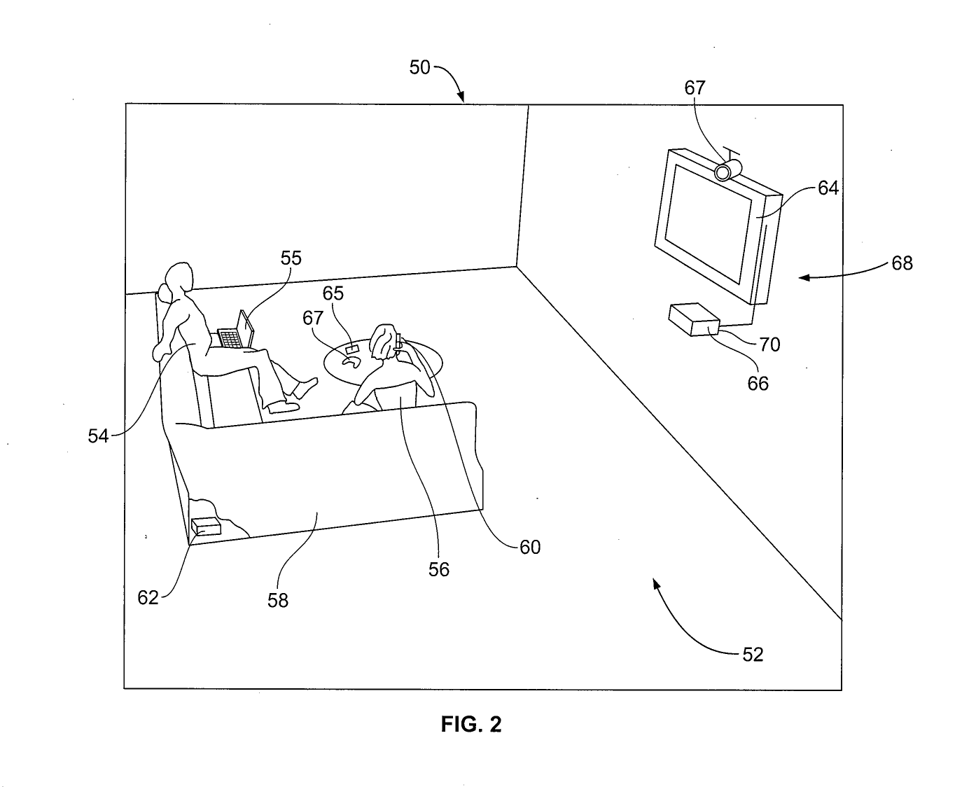

Turning now to FIG. 2, in one embodiment 50 a portion of a video viewing area such as television room 52 within student housing, is shown. The video viewing area 52 could be a portion of a lobby, a dedicated viewing room such as a theatre room, or within the confines in a student's personal living space such as a living room. Students 54, 56 are shown seated on couch 58. Student 56 is listening to a portable electronic device 60, either a mobile phone or a media player with wireless functionality. Student 54 has laptop 55 and is viewing television 64 which is connected to a media server 66. Media server 66 serves movies, advertising, other video/audio content, and provides games as a gaming console and is connected to a local computer network (not shown) with wired connection 70. The television 64 and media server 66, along with remote control 65 and game controller 67 form entertainment system 68.

Continuing with FIG. 2, media server 66 controls the available media for television 64 and may also receive video and audio information from video surveillance device 67 mounted over television 64. Information is gathered by the media server 66, such as the program and advertising content, viewing selections and durations (from selections made by remote 65), games played (from game controller 65 while playing), time and date stamp, identity of the student(s), video and audio recordings of the viewers, and so forth. This information is transmitted to a database server via cable 70.

Still referring to FIG. 2, in one embodiment identifier detection device 62 is shown mounted inside couch 58. In one example, the detection device 62 is a wireless transceiver, such as a wireless router or wireless network access point that is capable of interacting with a personal computer 55 or other electronic devices (e.g. cell phones, personal electronic devices, gaming consoles, etc.). Such devices typically have a media access control number mobile access ID (MAC ID) or other unique identifier that can be utilized to identify a person. For instance, a database can be configured to cross reference device identifiers with individuals who own such devices. In other embodiment, each user could have a unique password used to communicate with the identifier device.

The detection device 62 in the example shown is connected to a local computer network or the Internet and transmits information to a server having a database (not shown). The detection device 62 is used to detect student 56 who is using mobile phone 60, either when the phone is in the vicinity of the detection device 62 or the phone is placing a call or connects to the Internet. In this capacity, detection device 62 acts as a wireless network access point for communication of data and voice, and is capable or storing and logging information about these communications and identifying the student involved via a unique electronic serial number (ESN), or other identifier on her mobile phone 60. In one example, detection device 62 can also detect other identifiers, such as smart labels or RFID tags which are RF responsive devices that may be integrated or attached to an article such as clothing (not shown). Smart labels have previously been associated with a student in the database along with a unique identifier for the smart label. Thus, the tags and labels can serve as student identifiers as well as generate ethnographic data about the students' product purchases and usage. Finally, a student may be fitted with an implanted ID chip (thus, nearly always identifiable) or detected by the manual entry of some ID. For example, in order for student 54 to play a game or watch a movie on television 64, he will use either the remote 65 or the game controller 67 to enter a unique access code which is associated with him. The game console 66 receives the identifying information which is transmitted to the database server as before.

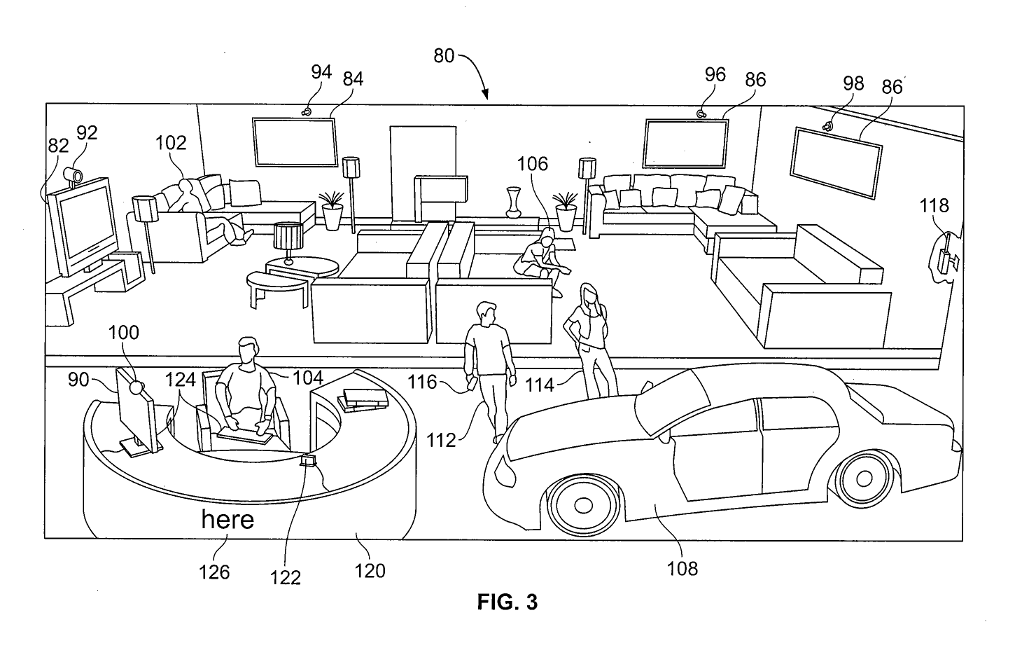

Turning now to FIG. 3, what is shown is a portion of the main lobby of a student dormitory in another preferred embodiment 80. The lobby contains a number of video viewing devices: flat-screen television 82, video displays 84, 86, and computer monitor 90. In this embodiment, each video viewing device has an associated video surveillance system: 92, 94, 96, 98, 100. The association between the video screens 82, 84, 86, 88, 90 and the surveillance cameras 92, 94, 96, 98,100 allows the gathering of data that comprises student activities in response to what is shown on the screen. For example, student 102 can be recorded while reacting to what he is viewing on video display 86, which is captured by video camera 98. Similarly students 104, 106 can be recorded by camera 100 watching monitor 90. As well, video surveillance cameras 92, 94, 96, and 98 may be used to view the dormitory sponsor's product placement automobile 108. But note that it is not mandatory that each video viewing device has a surveillance camera, or vice versa.

Still referring to FIG. 3, student activities surrounding automobile 108 can also be recorded by video surveillance cameras and audio surveillance devices such as a parabolic microphone (not shown) that are inside automobile 108. For example, students 112, 114 may be recorded verbally or visually reacting to car 108. Students 112, 114 may be identified by facial recognition in the video surveillance footage, or by RF-based identifiers such as the mobile media player 116 of student 112 which is detected by identifier detector 118.

Continuing with FIG. 3, student activities and transactions at the front desk 120 may be recorded by any nearby video surveillance 92, 94 as well as with card reader 122 which reads some form of student dormitory identifier. The front desk student 104 may also interact with the surveillance equipment and database(s) for security or maintenance purposes using desktop computer 124. In this preferred embodiment 80, identifier detection device 118 and video surveillance devices 92, 94, 96, 98 are wireless network appliances capable of streaming video and audio directly to a server on the dorm LAN or the Internet, while the desktop computer 90, television 82 and the video viewing devices 84, 86, 88 are wired to a computer and/or cable network with electrically or optically conductive cables (not shown). It should be understood that the type and numbers of connections be they wired or wireless; copper or fiber optic; cable, telephone, or Internet can be varied amongst the preferred embodiments of the current invention while remaining within the scope of the claims. Finally, the lobby of the preferred embodiment 80 also provides controlled branded and advertising content such as the display of mark 126, and video and still content advertisements that may be displayed on any of the video viewing devices such as wall-mounted video displays 84, 86.

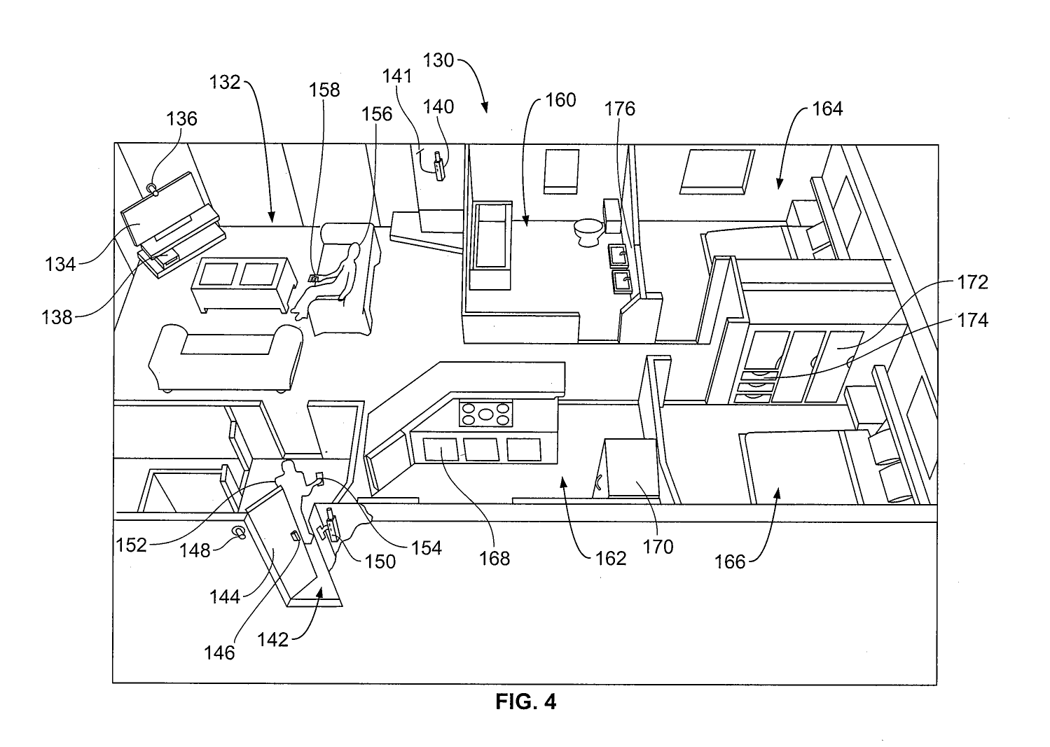

Turning now to FIG. 4, a preferred embodiment of a students' interior residential unit 130 is shown. The main personal living space is living room 132 having television 134, video surveillance devices 136, media server 138, and wireless network access point 140 with computer network connection 141. Student 156 uses remote 158 to control the display of television 134 (either controlling the TV 134 directly or the connected media server 138), while video surveillance unit 136 records his activities. In addition, information about student selections such as programs and advertising viewed, and duration of viewing can be captured by remote 158, the television 134, and media server 138. Information from these sources is then sent via network access point 140 to the database server. Still referring to FIG. 4, the unit 130 also comprises an entry 142 having a door 144, an access device such as room key reader 146, a video surveillance camera 148, and an identifier detector device 150. A student 152 entering entry 142 swipes room key 154, thereby opening the door, identifying himself, and generating a transmission of his entry information (identity, time/date room number, etc.) from the card reader key reader 146 to network access point 140 where it is transmitted to the database server. Similarly, when the student tenants 152 or 156 leave the apartment 130 identifier detector 154 will remotely detect a variety of student identifying devices such as the key card 154, laptop, mobile phone, MP3 player, tablet, smart label, or other radio frequency identifier (RFID) as explained above. The exit information is logged and sent to the database server as part of the ethnographic data.

Continuing to refer to FIG. 4, the ethnographic data may also comprise information about the products that the students purchase and otherwise use in their household. The living unit 130 has a bathroom 160, kitchen 162, first bedroom 164, and second bedroom 166 comprising various amenities and storage spaces. For example, kitchen products are stored in a cupboard or cabinet 168 and a refrigerator 170, and personal articles are stored in a closet 172, drawer 174, or bathroom cabinet 176. These articles and products may be identified by an RFID or a smart label by the identifier detector 150 when they are brought in to the apartment, used within the apartment, and removed from the apartment. In addition smart appliances such as refrigerator 170 may read the RFID or UPC code and transmit the information to the server database. Similarly, articles stored in cabinet 168, closet 172, drawer 174, bathroom cabinet 176 may all be tracked by local identifier detectors (not shown) to determine their unique identifiers and gather information about their entry, use and expiry, and then transmit the information to the database server.

Still referring to FIG. 4, the type of product monitoring described above not only associates personal products with a student for identification purposes (such as when worn or carried outside of the apartment), but it also enables cradle to grave monitoring of smart labeled products and smart appliances that are designed to report their information, usually wirelessly. For example, smart refrigerator 170 may detect a decrease in its coolant, or an increase in its interior temperature and report this condition to a server where a maintenance request can be generated automatically. Thus, this type of in-built monitoring is a boon to the dormitory maintenance, decreasing service times, food spoilage, and other costs. In another example, student 156 uses a student identifier credit card to purchase an Apple TV® media server 138 from dormitory sponsor Apple®. The device 156 has an RFID tag which is detected and recorded when it enters the room 130 by detector 150, carried by student purchaser 156. The media server 138 collects information about its usage, which is received by the database server. Thus usage of the device is tracked. However, before the lease of student 156 ends the Apple TV® 138 is removed from the apartment 130 after a failure was self-detected, but the device 138 was not repaired. Instead, it was replaced by another company's media server. A survey is dispatched to the student 156 inquiring as to the reasons for dissatisfaction with the product 138, and offering a rebate on their next purchase.

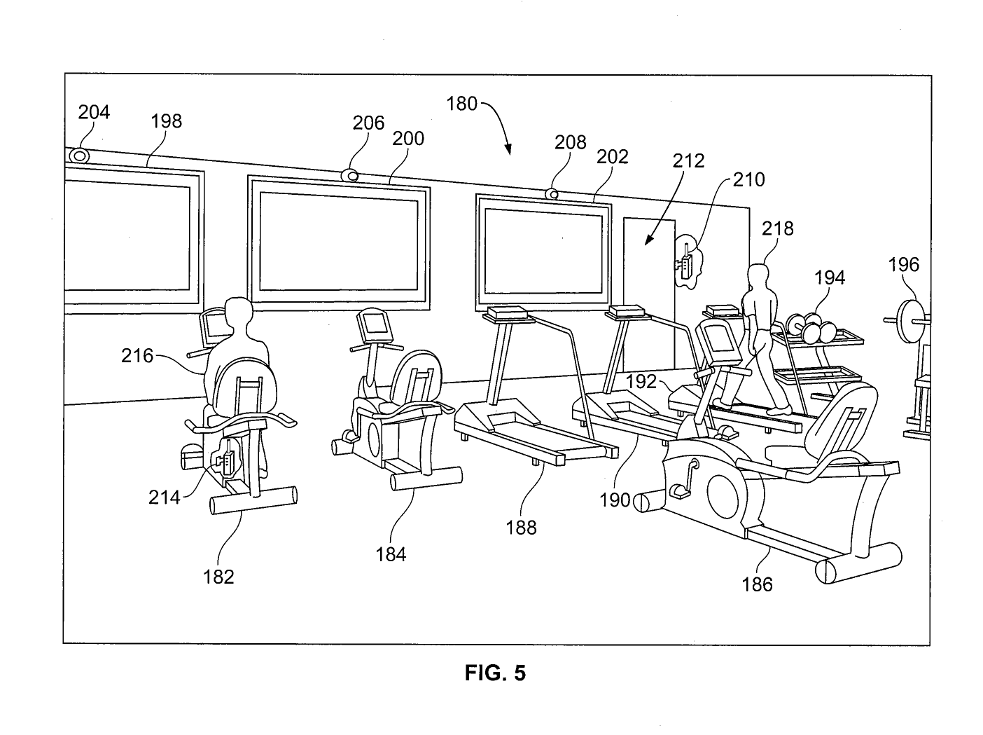

Referring now to FIG. 5, a preferred embodiment of a students' exercise room 180 is shown. The exercise room contains various exercise devices such as stationary bicycles 182, 184, 186, treadmills 188, 190, 192, and weight lifting equipment 194, 196. In addition there are wall-mounted video screens 198, 200, 202 respectively associated with video surveillance cameras 204, 206, 208. In addition there is an identifier detection device RFID detector 210 in entranceway 212 and there are individual identifier detection devices associated with exercise equipment such as detector 214 in stationary bicycle 182. When student 216 is using bicycle 182 the detector 214 detects some student identifier (which can be a variety of devices as described above). The usage by student 216 is recorded and transferred via a computer network to the database server. Similarly, student 218 using treadmill 192 may be detected by a detector 210 in doorway 212 when he enters the exercise room 180, and he may be detected while using the treadmill 192 by a detector in or on the treadmill 192 (not shown). While exercising the students 216, 218 in the exercise room 180 generally view a video screen 198, 200, 202 while a video surveillance camera 204, 206, 208 monitors the activities of the students 216, 218 and their reactions to the media displayed on the screen as well as their equipment usage. This data is gathered and transmitted to the database server as ethnographic data. Other embodiments may have other detectors such as a device for reading a student ID (not shown).

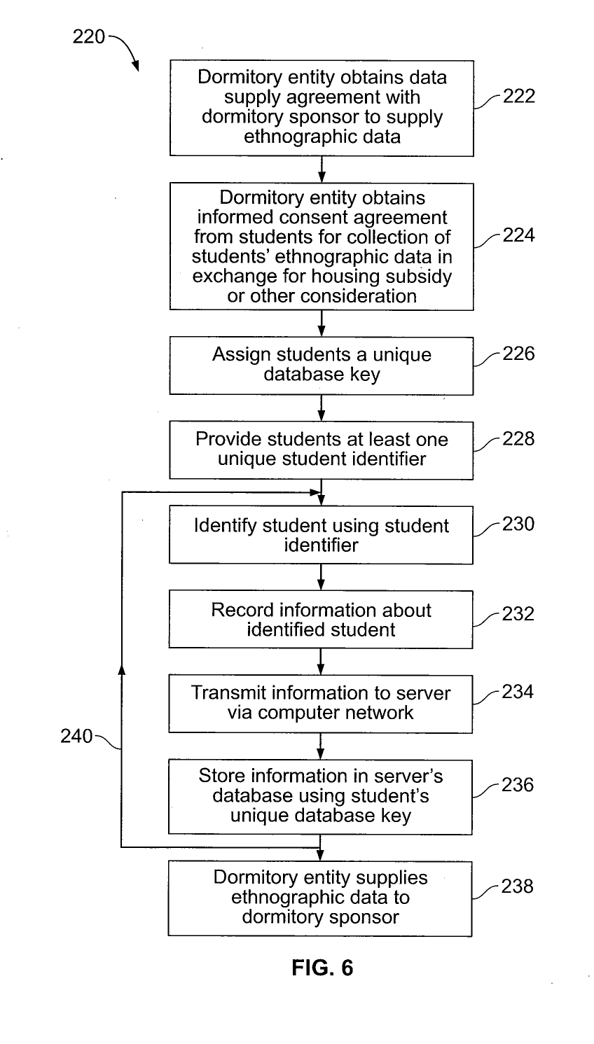

Referring now to FIG. 6, a preferred embodiment of a method of collecting ethnographic data 220 is shown as a flowchart. The method of the preferred embodiment 220 comprises steps of: 1) the building-controlling entity (such as the owner or management of a dormitory) obtaining a contract with a sponsor wherein the agreement comprises the supply of ethnographic data from the dormitory in exchange for some type of consideration (typically remuneration) from the dormitory sponsor 222; 2) the dormitory entity obtaining informed consent agreement from the students (and also the students' parents if any are minors) that allows the collection of the students' ethnographic data in exchange for subsidizing their dormitory expenses or other consideration 224; 3) a unique database key (identifier) is associated with each student 226; 4) a unique student identifier is given to each student (such as an ID card with identifier encoded on a magnetic or optic strip) 228; 5) the student is subsequently identified while in the dormitory or dormitory grounds 230; 6) the student activity information is recorded or otherwise gathered 232; 7) the information is transmitted to a server having an ethnographic database 234; 8) the information is stored in the server's ethnographic database using the student's unique database key 236; and 9) the dormitory controlling entity supplies the collected ethnographic data that was contracted for in step 1) to the dormitory sponsor. Note that steps 5-8 are repeated multiple times for multiple students 240.

Turning now to FIG. 7, in one embodiment 250 a block diagram of the invention is shown as a computer network with connected devices. The dormitory network 252 in one example is comprised of locations containing video display(s) 254, surveillance camera(s) 256, identifier detector(s) 258, a computer network access point 260, and server and/or surveillance storage 261. The locations can be dorm room(s) 262, a lobb(ies) 264, retail unit(s) 266, exercise room(s) 268 as well as other locations not shown (such as the dormitory entrance, grounds, study room, dining area, etc.). Each location in one example is connected to the dormitory's local area network 270 which allows access to one or more database servers 272 having ethnographic database(s) 274. Each dormitory 276 has one or more database servers 272 which are connected to a larger computer network 278 which can be a private network or the Internet. In one example, a central server 280 has a master ethnographic database 282, which consolidates the data from the dormitory server databases 274.

All the disclosed embodiments are useful in conjunction with collecting ethnographic data such as are used for the purpose of marketing research, or for the purpose of sociological research, or the like. There are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

For example, the dormitory could be enhanced by providing infrared, ultrasonic and other detection devices, GPS, and mobile-based applications, all to more carefully track the movements and activities of the student population either within building or throughout a campus area.

Moreover, the individual components or constructed in the disclosed configuration, but could include various combinations of surveillance and detection devices, computer networks, and living quarters. Furthermore, all the disclosed features, elements, and steps of each disclosed embodiment can be combined with, or substituted for, the disclosed features, elements, and steps of every other disclosed embodiment except where such features are mutually exclusive.

It is intended that the appended claims cover all such additions, modifications and rearrangements. Expedient embodiments of the present invention are differentiated by the appended claims.

1. A method of collecting ethnographic data from a population in a building, the method comprising the steps of:
designating an identification attribute for at least one member of the population;
providing at least one area, within or proximate to the building, with a member detection device;
utilizing the member detection device to identify the member when the member is within the area;
compiling member activity information when the member is located within the area.

2. The method of claim 2, further comprising:
transmitting the member activity information to a server for analysis.

3. The method of claim 1; wherein the step of compiling comprises:
recording member location data, wherein the member location data identifies the member's location within or relative to the building.

4. The method of claim 1, wherein the step of compiling comprises:
recording at least one of member arrival and member departure data relative to the member's respective arrival and departure from the area.

5. The method of claim 1, further comprising:
providing the member with at least one consumable media choice within the area, wherein the step of compiling comprises tracking the member's consumption of media.

6. The method of claim 5, wherein the at least one consumable media choice comprises at least one of music, video, gaming, and printed media.

7. The method of claim 6, further comprising:
providing the member with a plurality of delivery devices from which to consume the consumable media.

8. The method of claim 7, wherein the step of tracking comprises:
identifying content within the member's consumption of media.

9. The method of claim 7, wherein the step of tracking comprises:
identifying a selected media device from which the member consumes media.

10. The method of claim 1, wherein the step of compiling comprises:
recording information about advertising to which the member is exposed within the area.

11. The method of claim 1, further comprising:
conducting a survey within the building, wherein at least one member of the population participates in the survey, wherein the step of compiling comprises recording member response data from the survey.

12. The method of claim 1, wherein the step of compiling comprises:
recording information about the member's clothing preferences within the at least one area.

13. The method of claim 1, wherein the step of compiling comprises:
recording information about the member's usage of at least one good while within the area.

14. The method of claim 1, wherein the step of providing at least one area comprises:
providing a retail environment within the area; wherein the step of compiling comprises tracking member interaction with the retail environment.

15. The method of claim 14, wherein the step of tracking member interaction comprises tracking member purchases from the retail environment.

16. The method of claim 1, further comprising:
providing an exercise environment within the area; wherein the step of compiling comprises tracking member interaction with the exercise environment.

17. The method of claim 16, wherein the step of tracking comprises:
tracking at least one of a member exercise choice and an exercise equipment choice.

18. The method of claim 1, further comprising:
providing a dining environment within the area; wherein the step of compiling comprises tracking at least one of the member's food and drink choices within the area.

19. The method of claim 1, wherein the building comprises a student dormitory.

20. The method of claim 1, wherein the step of designating the identification attribute comprises:
designating the identification attribute as at least one of possession of an identity card, possession of a credit card, possession of a debit card, possession of a mobile phone having a specific electronic identification number, possession of a personal computing device having a specific media access control number, knowledge of a specific alphanumeric code, and possession of a particular biometric characteristic.

21. The method of claim 20, wherein the identification attribute comprises a biometric characteristic including at least one of a voice, face, and fingerprint character tic.

22. The method of claim 20, wherein the identification attribute comprises possession of an identity card, wherein the identity card includes at least one optical, magnetic, or RFID component.

23. The method of claim 1, further comprising:
entering a data supply agreement with a sponsor to supply ethnographic data from the population's activities, wherein the data supply agreement comprises remuneration or other consideration from the sponsor; and
obtaining an informed consent agreement from the at least one member of the population to gather ethnographic data from the member's activities within the area wherein the informed consent agreement comprises subsidizing the member's living costs with a subsidy or other consideration in exchange for the passive and active collection of ethnographic data from the member's activities;
creating an association between the member and a unique database key in a computer database; and associating at least one member identifier with the unique database key in at least one database record.

24. The method of claim 23 wherein the subsidy or other consideration comprises at least one of reductions, credits or discounts in a lease price, reductions, credits or discounts for one or more purchases within the building, reductions, credits or discounts for one or more on-line purchases at a participating website, reductions, credits or discounts for one or more purchases outside of the building.
